(19) United States
(12) Patent Application Publication
(10) Pub. No.: US 2024/0273271 A1
(43) Pub. Date: Aug. 15, 2024

(54) VERIFYING NONOVERLAPPING TRANSACTIONS DESCRIBED BY ASSERTIONS FOR SEQUENTIAL IMPLICATIONS

(71) Applicant: Synopsys, Inc., Mountain View, CA (US)

(72) Inventors: Dmitry Korchemny, Kfar Saba (IL); Naphtali Yehoshua Sprei, Modi'in-Maccabim-Re'ut (IL); Ilya Kudryavtsev, Zichron Yaakov (IL)

(21) Appl. No.: 18/167,861

(22) Filed: Feb. 12, 2023

(51) Int. Cl. G06F 30/33; G06F 30/327

(52) U.S. Cl. CPC G06F 30/33; G06F 30/327; G06F 2119/02

(57) ABSTRACT

An assertion for a sequential implication for a circuit design is received. The sequential implication defines a nonoverlapping transaction in which new transactions are not allowed while an existing transaction is still pending. The assertion is converted to a deterministic finite automaton on finite words in a machine-readable form, which is made available to verify the operation of the circuit design.

### TECHNICAL FIELD

The present disclosure relates to verification of electronic circuit designs and, more specifically, to verifying assertions for nonoverlapping transactions.

### BACKGROUND

Assertions are one technique used to detect errors in circuit designs described by a high-level specification such as a register transfer level (RTL) specification. Assertions describe the intended operation of a circuit. When the circuit design is simulated or otherwise analyzed, its behavior may be compared against the assertion to determine whether the design operates as intended. As circuit designs become larger and more complex, assertions are an important tool in designing and debugging these designs. In addition, the number of assertions and the number of different types of assertions to describe different behaviors is also increasing.

### SUMMARY

In some aspects, an assertion for a sequential implication for a circuit design is received. The sequential implication defines a nonoverlapping transaction in which new transactions are not allowed while an existing transaction is still pending. The assertion is converted to a deterministic finite automaton on finite words in a machine-readable form, which is made available to verify the operation of the circuit design.

Other aspects include components, devices, systems, improvements, methods, processes, applications, computer readable mediums, and other technologies related to any of the above.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1A is a timing diagram illustrating nonoverlapping transactions, according to embodiments of the present disclosure.

FIG. 1B is a flow diagram for verifying nonoverlapping transactions, according to embodiments of the present disclosure.

FIG. 2 shows a deterministic finite automaton for a sequential implication assertion, according to embodiments of the present disclosure.

FIG. 3 shows a general structure for a nondeterministic finite automaton on finite words (NFW) for an assertion, according to embodiments of the present disclosure.

FIG. 4 shows an NFW for an example property, according to embodiments of the present disclosure.

FIG. 5 shows a general structure for an NFW for a suffix implication assertion, according to embodiments of the present disclosure.

FIG. 6 shows a general structure NFW for a suffix implication for a continuously monitored assertion, according to embodiments of the present disclosure.

FIG. 7 shows an NFW for an example suffix implication assertion, according to embodiments of the present disclosure.

FIG. 8A shows an NFW for an example property, according to embodiments of the present disclosure.

FIG. 8B shows a deterministic finite automaton on finite words (DFW) for the property of FIG. 8A, according to embodiments of the present disclosure.

FIG. 9 depicts a flowchart of various processes used during the design and manufacture of an integrated circuit in accordance with some embodiments of the present disclosure.

FIG. 10 depicts a diagram of an example computer system in which embodiments of the present disclosure may operate.

### DETAILED DESCRIPTION

### Part I

Aspects of the present disclosure relate to verifying nonoverlapping transactions described by assertions for sequential implications. Assertions describe the intended operation of a circuit and may be used to verify whether a circuit design operates as intended.

One kind of implication operator used in assertions is suffix implication, which describes a transaction in which some sequence implies a property. In other words, the suffix implication states that, when the sequence occurs, then the property will be true. For example, two versions of suffix implications expressed in System Verilog Assertions (SVA) language are R|->P and R|=>P, where R denotes the sequence (a regular expression) and P denotes the property. Because the sequence comes before the property, the sequence is also referred to as the antecedent or antecedent sequence, and the property as the consequent or consequent property.

An assertion based on a suffix implication is a statement that a circuit design should operate according to the suffix implication. Assertions may be used to verify the operation of a circuit design. For example, an assertion stating that a request must be granted from 100 to 120 clock cycles after the request may be expressed in SVA using a suffix implication:

assert property (@(posedge clk) req |−> ##[100:120] gnt)

Here clk is the clock signal, req corresponds to the request, and gnt corresponds to the grant of the request. The notation ##[100:120] defines the time window of 100 to 120 clock cycles.

This assertion defines transactions. Each transaction starts with the occurrence of a request and ends when the request is either granted or fails to be granted in the specified time window. Multiple transactions may overlap. If req is asserted at clock cycles 20 and 70, there are two concurrently active (overlapping) transactions. When the second transaction starts at clock cycle 70, the previous transaction started at clock cycle 20 is still pending and has not yet been resolved.

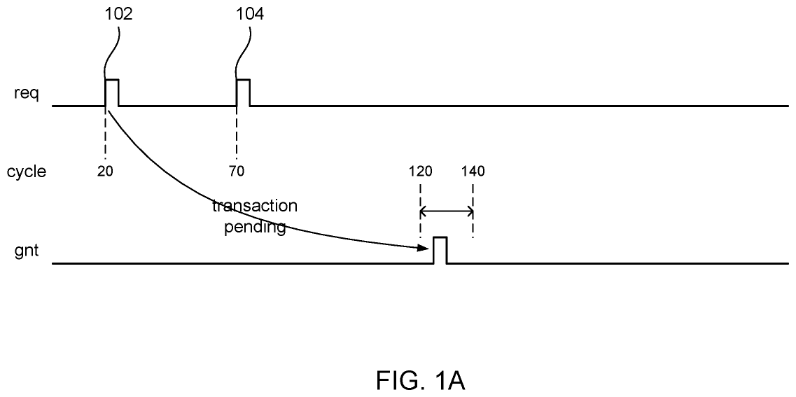

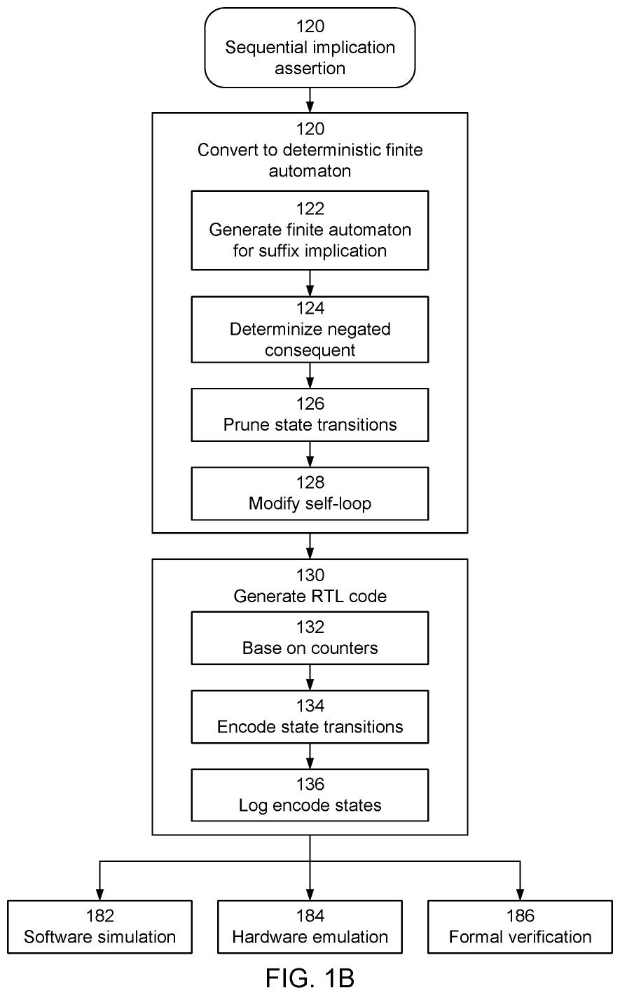

In some situations, overlapping transactions are not allowed. The intention is to ignore all new requests while there is an outstanding unresolved request. New transactions are not allowed while an existing transaction is still pending. FIG. 1A shows such a case for the above example. The first transaction starts with the request 102 at cycle 20 and will be resolved in the time window of 120 to 140 cycles, either with a gnt in that time window (as shown in FIG. 1) or a time out if there is no grant by cycle 140. If overlapping transactions are not allowed, the new request 104 at cycle 70 should be ignored because the request from cycle 20 is still unresolved. In some cases, it may be known in advance that transactions cannot overlap.

However, SVA and other assertion languages may not have a dedicated construct to describe nonoverlapping transactions. As a result, users may instead use a suffix implication, which will check all requests including requests that should be ignored (e.g., the new request at cycle 70 in the above example). However, this can lead to incorrect results, because an error detected for a request that should be ignored is not actually an error. Alternatively, users may manually write checkers for nonoverlapping transactions, but this is error-prone and requires extra work.

In the present disclosure, nonoverlapping transactions are described by a kind of implication operator used in assertions referred to as sequential implications. For convenience, the notation R|-->P and R|==>P is used for sequential implications. In the notation used in this disclosure, the sequential implications use two dashes in the implication arrow (-- or ==), whereas the suffix implications use one dash (- or =). There are two versions of sequential implications, as denoted by the use of -- >or ==>. In the version denoted by -- >, P starts on the same clock cycle that R is resolved. In the version denoted by ==>, P starts one clock cycle after R is resolved.

In order to make effective use of assertions based on sequential implications, these assertions are automatically converted to deterministic finite automata on finite words in a machine-readable form, such as RTL or software. These can then be used in software simulations, hardware emulations and/or formal verification, to verify whether the circuit design operates according to the assertion.

Technical advantages of the present disclosure include, but are not limited to, the following. The automatic conversion of sequential implication assertions to deterministic finite automaton and/or RTL or other forms provides an efficient way to implement assertions for nonoverlapping transactions, which may be used in formal verification, hardware emulation, and software simulation. As described in more detail below, the RTL implementation may be based on counters. This can yield a logarithmic reduction in size of the resulting automaton. As another advantage, the circuit design verifications can be run more quickly using fewer compute resources when nonoverlapping transactions are verified using sequential implications, rather than the more general suffix implications. In addition, for some cases, suffix implications may be replaced by equivalent sequential implications which speeds up the verification.

FIG. 1B is a flow diagram for verifying nonoverlapping transactions according to embodiments of the present disclosure. The nonoverlapping transaction is specified in an assertion for a sequential implication 110. At 120, the assertion is converted to a deterministic finite automaton. At 130, the finite automaton is implemented as RTL code (or other machine-readable forms). The automaton and/or its representation in RTL or other forms may be used in software simulation 182, hardware emulation 184 and/or formal verification 186 to verify the nonoverlapping transaction.

FIG. 1B also shows examples of steps 120 and 130. In one approach, the sequential implication assertion is converted to a deterministic finite automaton (step 120) as follows. At 122, an automaton is generated for the counterpart suffix implication. The sequential implication and its counterpart suffix implication have the same antecedent sequence and consequent property, but the suffix implication allows overlapping transactions whereas the sequential implication does not.

This automaton is then modified at 124, 126, 128 to account for the difference between the sequential implication and the counterpart suffix implication. Automata are defined by states and transitions between states. The states include an initial state and a state transition from the initial state back to the initial state, also referred to as a self-loop. The automata for the sequential implication and the counterpart suffix implication have the same states, but the state transitions are modified. At 124, the negated consequent property is made deterministic, if necessary. These modifications are described in more detail below. At 126, state transitions are pruned so that every activation of the initial state results in only a single run of the finite automaton, thus preventing overlapping transactions. At 128, the self-loop is modified to add a condition to prevent overlapping transactions.

Moving to 130, in one approach, RTL code is generated to implement the deterministic finite automaton as follows. At 132, the automaton is implemented based on counters. At 134, the state transitions of the automaton are encoded to generate the RTL code. At 136, the states of the automaton are implemented in the RTL code according to a logarithmic encoding. These modifications are also described in more detail below.

For purposes of explanation and without loss of generality, assume that the sequential implication is a top-level property in an assertion:

assert property (R |−−s> P)
or
assert property (R|==> P).

The above assertion is not required. The techniques described herein are also applicable when the sequential implication is not the top-level property.

In addition, the version “assert property (R|==>P)” is a shorthand for “assert property (R##1 1|-->P).” Therefore, this disclosure considers only the first form denoted by -->, but the techniques described herein are also applicable to the other form.

The lefthand-side operand R is the antecedent sequence or simply antecedent, and the righthand-side P is the consequent property or simply consequent. Without loss of generality, the antecedent may be expressed as a Boolean expression. This Boolean expression corresponds to the accepting state of the antecedent's automaton. The semantics of the sequential implication assertion “assert property (R|-->P)” are defined as follows:
Assume t=−1. Perform the following steps while t<∞.
At the first clock cycle i>t when the antecedent has a match, the property P is evaluated. If j= [symbol] (i, P)<∞ then the attempt succeeds; assume t=j; otherwise, if k= [symbol] (i, P)<∞ then the attempt fails; assume t=k. Otherwise, assume t=∞.
All other attempts are discarded.

Here, the time at which the property P is determined to be satisfied is the success time [symbol] (i, P), and the time at which the property P is determined to be violated is the failure time [symbol] (i, P). See Part II for their formal definitions. These semantics mean that the sequential implication discards all new attempts when there is an active attempt. An attempt occurs when the antecedent has a match. The attempt is active while the consequent is not yet resolved.

The version of the sequential implication “assert property (R|==>P)” allows a new attempt to start at the time of resolution of the consequent P:
Assume t=0. Perform the following steps while t<∞.
At the first clock cycle i≥t when the antecedent has a match, the consequent value is checked. If j= [symbol] (i, P)<∞ then the attempt succeeds; assume t=max (j, t+1); otherwise, if k= [symbol] (i, P)<∞ then the attempt fails; assume t=max (k, t+1). Otherwise, assume t=∞.
All other attempts are discarded.
   This latter version may be treated similarly to the former one. Therefore, this disclosure describes the former version without loss of generality.

As an example, consider the behavior of assertion

assert property (a |−−> ##[1:2] b);

on the signal trace shown in Table 1. The assertion is that b=1 one or two clock cycles after a=1.

TABLE 1
Signal trace fragment

| Clock cycle | 0 | 1 | 2 | 3 | 4 | 5 | 6 | 7 | 8 |
|---|---|---|---|---|---|---|---|---|---|
| a | 1 | 1 | 1 | 0 | 1 | 0 | 1 | 1 | 0 |
| b | 1 | 0 | 0 | 1 | 1 | 0 | 1 | 1 | 1 |

The start times of its active attempts are given in Table 2. The antecedent a is true (a=1) at cycles 0,1,2,4,6,7, but only cycles 0,4,7 are start times of attempts. Cycles 1,2,6 are not start times of an attempt because another attempt is pending at that time.

TABLE 2
Sequential implication attempts

| Attempt start, t | Resolution time, [symbol] (t, ##[1:2]!a) | Success/Failure |
|---|---|---|
| 0 | 2 | Failure |
| 4 | 6 | Success |
| 7 | 8 | Success |

An attempt succeeds if b is true during the following one or two cycles, and the attempt fails if b is false during those cycles. The resolution time [symbol] ( ) is the time when an attempt is determined to be either a success or a failure.

Step 120 of FIG. 1B creates a deterministic finite automaton on finite words (DFW) for a sequential implication assertion of the form

assert property (e |−−> P);

As described previously, an automaton is represented by states and transitions between states. The automaton is finite if it has a finite number of states. It is deterministic if, given a current state, there is only one possible state transition (leading to exactly one state) for a given condition. In a nondeterministic automaton, the same condition may have multiple state transitions leading to multiple different states. Finite words means that the automaton run is finite. It will resolve in a finite number of cycles and cannot run forever. The process 120 first generates the automaton for the counterpart suffix implication. It then includes the following stages, which are described in more detail below:
1) Determinization of the negated consequent property automaton (step 124) and pruning all paths going out the accepting and success states (step 126).
2) Restriction on the former unconditional self-loop with the negation of the gating condition (step 128). Thus, the entire automaton for the sequential implication assertion becomes deterministic.

The determinization of the negated consequent (step 124) captures the first success/failure points of the attempt. Pruning the paths going out the accepting and success states (step 126) assures that the failure/success for the given attempt fires at most once, so that not more than one success/failure point is captured. The additional gating condition for the transitions going out of the initial state (step 128) has the form sa∥sr for the sequential implication. Here, sa stands for the accepting state and sr stands for the rejecting state, as described in Part II. Thus, the nondeterministic finite automaton (NFW) for the sequential implication differs from the NEW for the suffix implication in that the non-self-loop outgoing transitions of the initial state of the sequential implication are labeled with e∧c∧g, where c is the original condition in the suffix implication and g=sa∨sr, and the former unconditional self-loop is labeled with 147 g. Here, ∧ is the AND operation, ∨ is the OR operation, and ¬ is the NOT operator.

As an example, consider a sequential implication stating that request req is granted in two to four clock cycles, and the new requests are ignored so long as there is an outstanding request:

assert property (@(posedge clk) req |−−> ##[2:4] gnt);

To build the automaton for the sequential implication, first build the automaton for the suffix implication:

assert property (@(posedge clk) req |−> ##[2:4] gnt);

This automaton has the following implementation in RTL:

```
bit s0 = 0, s1 = 0, s2 = 0, s3 = 0, sa = 0; sr = 0;
let acc = !gnt && s3;
let rej = gnt && (s1 | | s2 | | s3) ;
always @(posedge clk) begin
  s0 <= req; s1 <= s0; s2 <= !gnt && s1; s3 <= !gnt && s2;
  sa <= acc;
  sr <= rej;
end
```

Here e is req, and c=1. Also, s0 is the initial state, sa is the accepting state, and sr is the rejecting state. The negated consequent's automaton is already deterministic, so there is no need to determinize it.

The resulting automaton for the sequential implication (the first form) is encoded in RTL as:

```
bit s0 = 0, s1 = 0, s2 = 0, s3 = 0, sa = 0, sr = 0, gate = 1;
let acc = !gnt && s3;
let rej = gnt && (s1 | | s2 | | s3);
always @(posedge clk) begin
  s0 <= req && gate; s1 <= s0; s2 <= !gnt && s1; s3 <= !gnt && s2;
  sa <= acc;
  sr <= rej;
  gate <= acc | | rej;
end
```

Indicator sa indicates the attempt failure, and sr indicates its success. The difference here is that the gate condition is added to the self loop for s0, the initial state.

A counter-based implementation of the sequential implication can be generated (step 132). The automaton for the sequential implication may be made deterministic by restricting its initial state self-loop with the negation of the gating condition, which reflects the fact that there are no simultaneously active attempts. In addition, the negated consequent automaton is usually easy to determinize, if it is not deterministic already.

As an example, consider the following assertion:

assert property (@(posedge clk) req |−> ##[5:10] gnt);

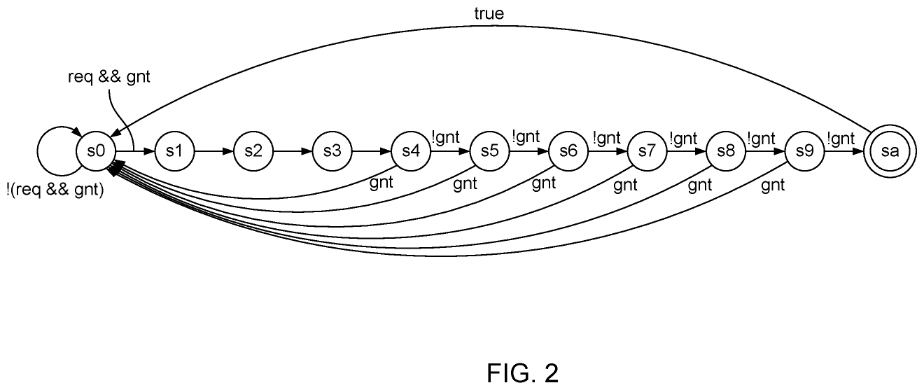

The corresponding DFW is shown in FIG. 2. The nodes in FIG. 2 are the states of the automaton, and the arrows between nodes are the state transitions. In FIG. 2, s0 is the initial state, sa is the accepting state. The rejecting state sr is not shown for clarity. Any state transitions not shown in FIG. 2 lead to the rejecting state. A gating condition is added to the self-loop for so, which condition is not present in the automaton for the counterpart suffix implication. The gating condition is defined as: one of the states s4, . . . , s9 is active and gnt is high, or the accepting state sa is active. Note that the back arrow from sa to s0 is not needed for formal verification. For formal verification, the accepting state reachability means assertion refutation, and there is no need to move beyond it.

This automaton can be implemented in RTL using logarithmic encoding (step 136), as described in more detail in Part II. With the logarithmic encoding, the states s* are implemented by the 4-bit counter cnt. This automaton can be represented as:

```
bit [3:0] cnt = 0;
bit sa = 0, sr = 0;
let acc = (cnt == 10);
let rej = (cnt >= 5 && cnt < 10 && gnt);
always @(posedge clk) begin
  if (cnt == 0 && req) begin cnt <= 1; end
  if (cnt >= 1 && cnt < 5) cnt <= cnt + 1;
  if (cnt >= 5 && cnt < 10) cnt <= gnt ? 0 : cnt + 1; // Successful attempt
  if (cnt == 10) cnt <= 0; // Failing attempt
  sa <= acc;
  sr <= rej;
end
```

Note that the automaton for the counterpart suffix implication property

assert property (@(posedge clk) req |-> ##[5:10] gnt);

is nondeterministic and cannot be encoded with a counter.

### Part II

Part II provides more information on the techniques described in Part I. First consider a synchronous model of a hardware when all signal changes are synchronized by the system clock. In this case the hardware behavior may be defined as an (infinite) series of all its signal values at each cycle of the system clock. This series of signal values is a signal trace. The clock cycles will be numbered from 0; the terms clock cycle and time will be used interchangeably. For simplicity, assume all design signals to be Boolean, assuming values 1 (true) and 0 (false). Table 3 contains an example of an initial fragment of a trace of two signals, a and b.

TABLE 3
Signal trace fragment

| Clock cycle | 0 | 1 | 2 | 3 | 4 | 5 | 6 | 7 | 8 |
|---|---|---|---|---|---|---|---|---|---|
| a | 0 | 1 | 1 | 0 | 0 | 1 | 0 | 0 | 0 |
| b | 1 | 1 | 1 | 0 | 1 | 0 | 1 | 1 | 1 |

A regular linear temporal logic (RLTL) property (or, simply, property) is a temporal statement, which has an associated start point (time) at clock cycle i and can be either true or false at this time. An RLTL sequence (or, simply, sequence) with a start point at clock cycle i is a regular expression over signal values having zero, one or several match (or tight satisfaction) points in clock cycles j₁, j₂, . . . ≥i.

A signal trace on which a property is satisfied, is called a property witness. A signal trace on which a property is violated, is called a property counterexample. Though the trace may be infinite, in some cases, a witness (or a counterexample) trace has a finite prefix such that all its possible extensions are also witnesses (counterexamples). Such prefixes are called finite witnesses (counterexamples). The properties whose all counterexamples are finite, are called safety properties. The properties whose all witnesses are finite, are called co-safety properties.

As an illustration, consider a property stating that signal a eventually has a value true. The trace of a, shown in Table 3 has a finite prefix 0, 1 witnessing the truth of this property. Any extension of this prefix is also a witness. Therefore, this property is a co-safety property. However, it is not safety, because its only counterexample is infinite (0, 0, . . . ). The property stating that signal b is always true has a finite counterexample on the trace of b shown in Table 3: 1, 1, 1, 0. In fact, all its counterexamples are finite, and it is a safety property. However, it is not co-safety, because its only witness is infinite (1, 1, . . . ).

The following are several examples of sequence and property specification.

A simple sequence is a Boolean sequence—a Boolean expression on signal values, such as a && b, where && is the AND operator. The Boolean sequence may only have a match at its start point. Thus, for the signal trace shown in Table 3, Boolean sequence a && b has a match at time 1 when starting at time 1, and a match at time 2 when starting at time 2; it does not have matches when starting at time 0, 3, . . . , 8.

Sequence a ##1 b (a is directly followed by b) has a match at time 2 for start time 1 of the sequence, because a=1 at cycle 1 and then b=1 at cycle 2. The sequence also has a match at time 6 for start time 5 of the sequence. A sequence may be the basis of a sequential property.

Thus, sequential (Boolean) property a && b is true at clock cycles 1 and 2, and sequential property a ##1 b is true at clock cycles 1 and 5.

Property always P (where P is a property) holds at clock cycle i if P holds at every clock cycle j≥i. The top level always property defines a series of evaluation attempts of property P starting at clock cycles i, i+1, . . . . If one of these attempts fails, property always P fails, otherwise, it succeeds.

One of the most commonly used RLTL constructs is the suffix implication which has the following forms: R|->P or R|=>P. These two forms are defined the same as above for sequential implications. Here R is a sequence, called antecedent, and P is a property, called consequent. It is sufficient to consider only the first form, because the other form is derived and may be equivalently rewritten as: R ##1 1|->P.

For the trace shown in Table 3, property !a ##1 a |->!b ##1 b fails at clock cycle 0 (the consequent does not hold at the match time of the antecedent), and holds at other clock cycles. It holds at clock cycle 4 because the consequent holds at the match of the antecedent, and in clock cycles 1-3, 5-7 the property holds vacuously because its antecedent has no match.

The antecedent may always be equivalently rewritten as a Boolean signal which has the value true at the match time of the antecedent, and false, otherwise. In SVA notation this Boolean is denoted as R.triggered. Therefore, it may be assumed that the implication antecedent is a Boolean.

Standalone SVA assertions are continuously monitored, so that (omitting the clock specification here)

assert property (e |-> P);

is essentially equivalent to checking property always (e|->P). That is, the top-level property should be considered as being in the scope of an always operator. Here, e is the Boolean representing the antecedent.

With every property, given its start time i and a signal trace, it is possible to associate values [symbol] —property success time, and [symbol] —property failure time, [symbol] , [symbol] 24 i, so that either [symbol] =∞ or [symbol] =∞ (or both [symbol] and [symbol] ; the latter can happen for liveness properties only). Success time [symbol] is the earliest clock cycle witnessing the property success. When the property holds, its success time may be finite. If it fails, its success time is assumed to be infinite. Failure time [symbol] is the earliest clock cycle witnessing the property failure. When the property succeeds, its failure time is infinite. If it fails, the failure time may be finite (in fact, it is always finite for failing safety properties).

Use [symbol] (i, P) and [symbol] (i, P) to denote success and failure times of property P starting at clock cycle i, correspondingly. Success and failure times of property P=a|=>b on the trace shown in Table 3, is shown in Table 4.

TABLE 4
Success and failure times

| Property start time, i | 0 | 1 | 2 | 3 | 4 | 5 | 6 | 7 | 8 |
|---|---|---|---|---|---|---|---|---|---|
| Success time, [symbol] (i, P) | 1 | 2 | ∞ | 3 | 4 | 6 | 6 | 7 | 8 |
| Failure time, [symbol] (i, P) | ∞ | ∞ | 3 | ∞ | ∞ | ∞ | ∞ | ∞ | ∞ |

Define the resolution time of property P starting at clock cycle i as:

$$( i , P ) = \{ \begin{matrix}( i , P ) , if ( i , P ) < ∞ , \\ ( i , P ) , if ( i , P ) < ∞ , \\ ∞ , othe rwise .\end{matrix}$$

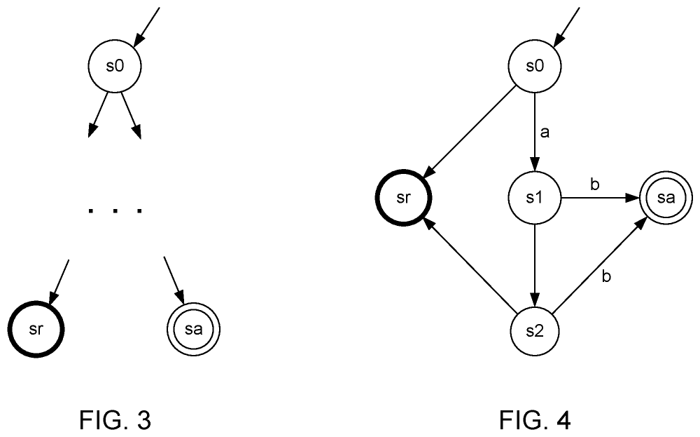

Safety assertions (or co-safety properties) may be represented by nondeterministic finite automata on finite words (NFW) with a single initial and a single accepting state. To make an automaton transitions total (i.e., the disjunction of the conditions of all transitions going out of any state be true), in the general case, a rejecting state, corresponding to the dead-end, should also be added to the automaton, as shown in FIG. 3 (self-loops are omitted in the accepting and in the rejecting state). The following conventions are used. The initial state s0 is depicted as a node with a dangling incoming arrow, the rejecting state sr is shown with a thick border, and the accepting state sa is shown with a double border. If there is an automaton run leading to the accepting state, then the property is true. Otherwise, the property is false. The equivalent statement is that all its runs lead to the rejecting state.

The input alphabet of this automaton form the sets of variables, defining the system state. For hardware circuits it corresponds to the set of all combinations of its signal values. The automaton inputs are words—sequences of its alphabet letters; these words correspond to the signal traces.

As an example, consider the sequential property defined by sequence a ##[1:2] b (b follows a either in one or two clock cycles). Its automaton is shown in FIG. 4. The transition arrows are annotated with transition condition. The absence of an annotation corresponds to the unconditional transition, that is its transition condition is true.

A property automaton may be represented in RTL by encoding the incoming transitions for each state. Thus, the automaton in FIG. 4 may be encoded as follows, assuming the property clock is @(posedge clk). The examples in this disclosure use System Verilog notation or a pseudocode notation based on System Verilog for RTL.

```
let acc = b && s1 ∥ b && s2;
let rej = !s0 ∥ s2;
bit s0 = 1, s1 = 0, s2 = 0, sa = 0, sr = 0;
always @(posedge clk) begin
  s1 <= a && s0;
  s2 <= !b && s1;
  sa <= acc;
  sr <= rej;
end
```

Here, names acc and rej are assigned to the incoming conditions of the accepting state sa and the rejecting state sr, correspondingly.

The assertion automata are negative. Their accepting state corresponds to the assertion failure. If the assertion automaton is deterministic, its rejecting state corresponds to the assertion success. In the assertion “assert property (e|->P),” if P is a safety property, then its negation on which the assertion is based will be co-safety and the corresponding automaton will be on finite words.

Consider now an NFW for an assertion with a suffix implication as its top property (recall that we consider only implications with the safety consequent P):

assert property (e |-> P);

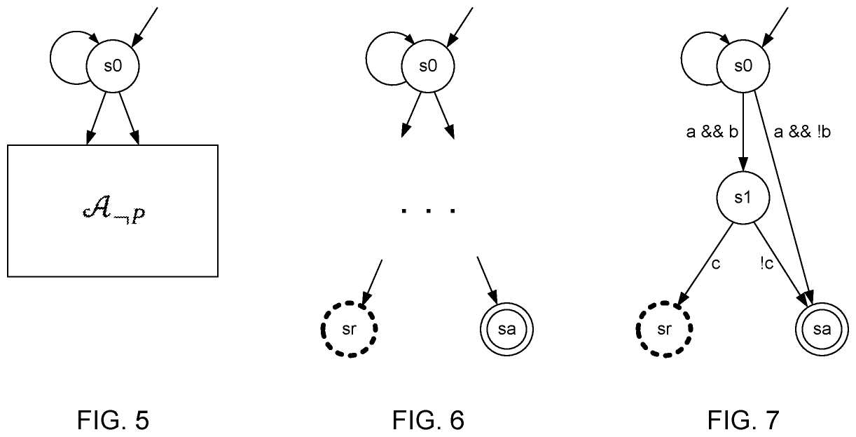

The corresponding NFW may be implemented as shown in FIG. 5. Its initial state s0 has a self-loop, corresponding to the implicit always operator, and [symbol] is the NEW for property P negation, with the removed initial state. The resulting initial state is connected to all the direct successors of the former initial state of [symbol] , and these transitions are labeled with e∧c, where c is the former condition of the transition in the standalone automaton [symbol] .

The accepting state of [symbol] becomes the accepting state of the assertion, but the rejecting state of [symbol] becomes a regular state of the assertion automaton. The resulting automaton for the suffix implication for a continuously monitored assertion is shown in FIG. 6. It has the same form as the automaton for the general co-safety property shown in FIG. 3 with the exception that its initial state always has an unconditional self-loop. Also, the rejecting state of [symbol] is shown with a dotted line, to stress that it is no longer a rejecting state. This state may be referred to as a success state of the assertion attempt.

As an example, consider assertion:

assert property (a |-> b ##1 c);

Its automaton is shown in FIG. 7. The RTL encoding of this automaton is as follows:

```
let acc = a&& !b ∥ !c && s1;
let rej = c && s1;
bit s1 = 0, sa = 0, sr = 0;
always @(posedge clk) begin
  s1 <= a && b;
  sa <= acc;
  sr <= rej;
end
```

Here, there is no need to encode the initial state because the value of the corresponding variable would always be 1.

A nondeterministic finite automaton (NFW) may be determinized—converted into an equivalent deterministic finite automaton on finite words (DFW). However, this determinization in the worst case may involve an exponential blowup in the number of NEW states.

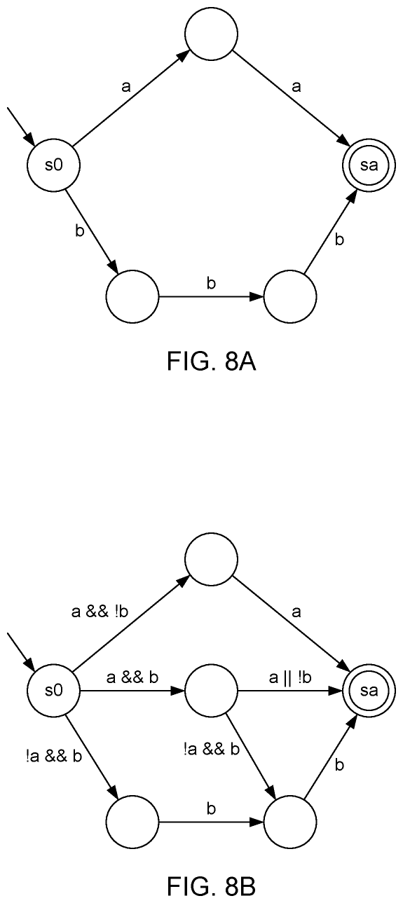

The NEW determinization may be illustrated on the example of the sequential property a[*2] or b[*3]. This property succeeds if either a is repeated two times or b is repeated three times. Its NFW is shown in FIG. 8A (rejecting state and its incoming transitions are omitted). This automaton fires multiple times: twice when either a is true in the first two cycles or b is true in the first three cycles. This makes the automaton nondeterministic.

FIG. 8B shows the pruned deterministic version of this automaton, omitting the rejecting state. This automaton fires at most once. An automaton is deterministic if every input word defines only a single run, which is either accepting if it leads to the accepting state, or rejecting if it leads to the rejecting state.

The states of a DFW may be enumerated and identified with their indices. The state transitions may be encoded as:

sₖ <= fₖ(s₁, ..., sₙ);

where fₖ is a function on states, and n is a number of states. A DFW state transition may be also rewritten as

if (fₖ(m == 1, ..., m == n)) m <= k;

Here m is an integer variable containing the number of the currently active state. This state encoding is called logarithmic encoding, because the number of bits required to encode the states is logarithmic in the total number of states.

This encoding is useful for a string of DFW states (i.e., the sequence of states with no forking, except, maybe, to the success state), such as:

sᵢ <= fᵢ(s₁, ..., sᵢ₋₁, sᵢ₊ₖ, ...);
sᵢ₊₁ <= a && sᵢ;
sᵢ₊₂ <= a && sᵢ₊₁;
...
sᵢ₊ₖ <= a && sᵢ₊ₖ₋₁;

Here a is a Boolean expression, and i+k≤n.

In this case, states sᵢ, sᵢ₊₁, . . . , sₙ may be replaced with counter cnt of size N=┌log₂(k+1)┐, where ┌x┐ stands for the ceiling function: the least integer number greater or equal to x. So, the encoding of this automaton part would be:

bit [N-1:0] cnt = 0;
if (fᵢ(s₁, ..., sᵢ₋₁)) cnt <= 1;
if (cnt == k ∥ (cnt < k && !a)) cnt <= 0;
else if (cnt > 0) cnt <= cnt + 1;

This encoding may be generalized for the following situation:

```
  sᵢ <= fᵢ(s₁, ..., sᵢ₋₁);
  sᵢ₊₁ <= a₁&&sᵢ;
  ...
  sᵢ₊ₖ_{₁} <= a₁&&sᵢ₊ₖ_{₁}₋₁;
  sᵢ₊ₖ_{₁}₊₁ <= a₂&&sᵢ₊ₖ_{₁};
  ...
  sᵢ₊ₖ_{₂} <= a₂&&sᵢ₊ₖ_{₂}₋₁;
  sᵢ₊ₖ_{₂}₊₁ <= a₃&&sᵢ₊ₖ_{₂};
  ...
  sᵢ₊ₖ_{ₗ} <= aₗ&&sᵢ₊ₖ_{ₗ}₋₁;
Here k₁ < k₂ < ... < kₗ and i + kₗ ≤ n.
```

The corresponding logarithmic encoding of this part of DFW may be:

bit [N-1:0] cnt = 0;
if (fᵢ(s₁, ..., sᵢ₋₁)) cnt <= 1;
if (cnt == kₗ) cnt <= 0;
if (cnt >= 1 && cnt < k₁) cnt <= a₁ ? cnt + 1 : 0;
if (cnt >= k₁ && cnt < k₂) cnt <= a₂ ? cnt + 1 : 0;
...
if (cnt >= kₗ₋₁ && cnt < kₗ) cnt <= aₗ ? cnt + 1 : 0;

Note that expression Vₜ₌ₚ^{q}sₜ can then be replaced with cnt>=p && cnt<=q, where i≤p≤q≤i+kₗ.

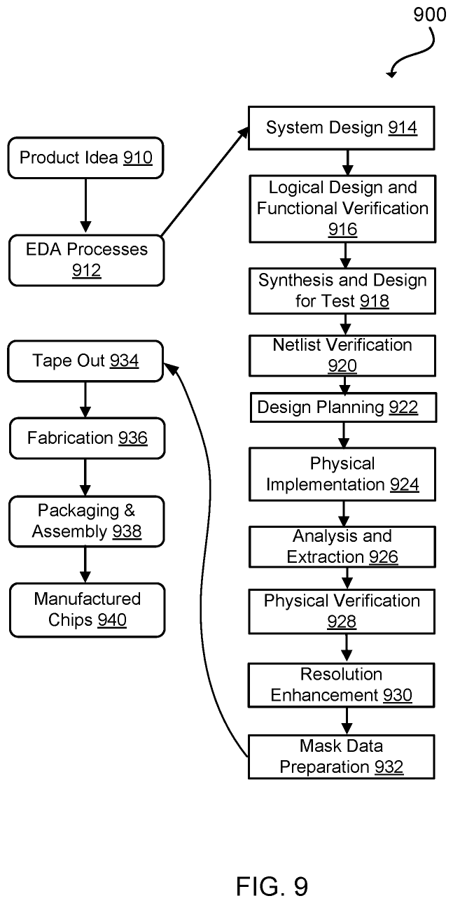

FIG. 9 illustrates an example set of processes 900 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 910 with information supplied by a designer, information which is transformed to create an article of manufacture that uses a set of EDA processes 912. When the design is finalized, the design is taped-out 934, which is when artwork (e.g., geometric patterns) for the integrated circuit is sent to a fabrication facility to manufacture the mask set, which is then used to manufacture the integrated circuit. After tape-out, a semiconductor die is fabricated 936 and packaging and assembly processes 938 are performed to produce the finished integrated circuit 940.

Specifications for a circuit or electronic structure may range from low-level transistor material layouts to high-level description languages. A high-level of representation may be used to design circuits and systems, using a hardware description language (‘HDL’) such as VHDL, Verilog, System Verilog, SystemC, MyHDL or OpenVera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 9. The processes described by be enabled by EDA products (or EDA systems).

During system design 914, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 916, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 918, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 920, the netlist is checked for compliance with timing constraints and for correspondence with the HDL code. During design planning 922, an overall floor plan for the integrated circuit is constructed and analyzed for timing and top-level routing.

During layout or physical implementation 924, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 926, the circuit function is verified at the layout level, which permits refinement of the layout design. During physical verification 928, the layout design is checked to ensure that manufacturing constraints are correct, such as DRC constraints, electrical constraints, lithographic constraints, and that circuitry function matches the HDL design specification. During resolution enhancement 930, the geometry of the layout is transformed to improve how the circuit design is manufactured.

During tape-out, data is created to be used (after lithographic enhancements are applied if appropriate) for production of lithography masks. During mask data preparation 932, the ‘tape-out’ data is used to produce lithography masks that are used to produce finished integrated circuits.

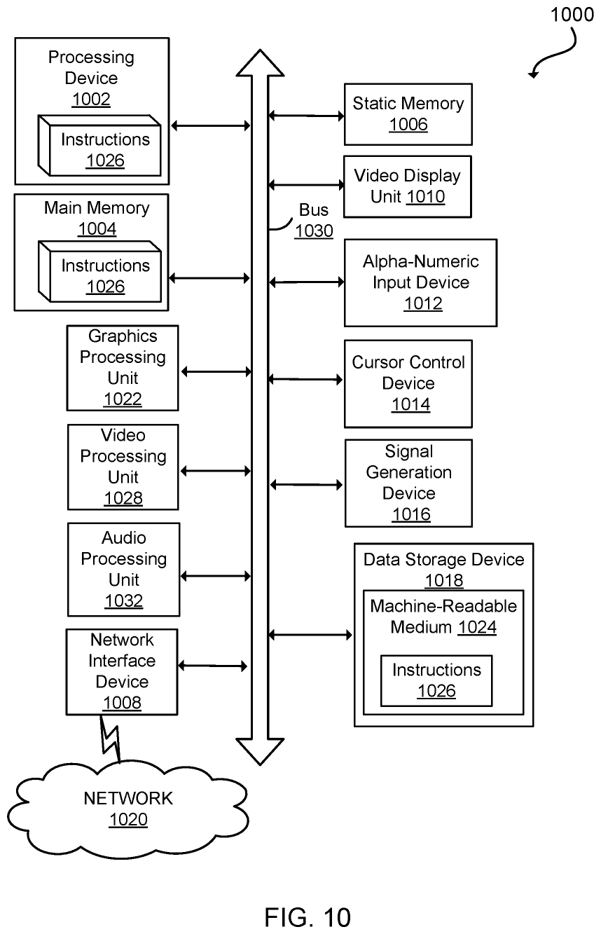

A storage subsystem of a computer system (such as computer system 1000 of FIG. 10) may be used to store the programs and data structures that are used by some or all of the EDA products described herein, and products used for development of cells for the library and for physical and logical design that use the library.

FIG. 10 illustrates an example machine of a computer system 1000 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1000 includes a processing device 1002, a main memory 1004 (e.g., read-only memory (ROM), flash memory, dynamic random access memory (DRAM) such as synchronous DRAM (SDRAM), a static memory 1006 (e.g., flash memory, static random access memory (SRAM), etc.), and a data storage device 1018, which communicate with each other via a bus 1030.

Processing device 1002 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1002 may also be one or more special-purpose processing devices such as an application specific integrated circuit (ASIC), a field programmable gate array (FPGA), a digital signal processor (DSP), network processor, or the like. The processing device 1002 may be configured to execute instructions 1026 for performing the operations and steps described herein.

The computer system 1000 may further include a network interface device 1008 to communicate over the network 1020. The computer system 1000 also may include a video display unit 1010 (e.g., a liquid crystal display (LCD) or a cathode ray tube (CRT)), an alphanumeric input device 1012 (e.g., a keyboard), a cursor control device 1014 (e.g., a mouse), a graphics processing unit 1022, a signal generation device 1016 (e.g., a speaker), graphics processing unit 1022, video processing unit 1028, and audio processing unit 1032.

The data storage device 1018 may include a machine-readable storage medium 1024 (also known as a non-transitory computer-readable medium) on which is stored one or more sets of instructions 1026 or software embodying any one or more of the methodologies or functions described herein. The instructions 1026 may also reside, completely or at least partially, within the main memory 1004 and/or within the processing device 1002 during execution thereof by the computer system 1000, the main memory 1004 and the processing device 1002 also constituting machine-readable storage media.

In some implementations, the instructions 1026 include instructions to implement functionality corresponding to the present disclosure. While the machine-readable storage medium 1024 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 1002 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
receiving an assertion for a sequential implication for a circuit design, wherein the sequential implication defines a nonoverlapping transaction in which new transactions are not allowed while an existing transaction is still pending;
converting, by a processing device, the assertion to a machine-readable form of a deterministic finite automaton on finite words; and
making the machine-readable form available to verify operation of the circuit design based on the deterministic finite automaton.

2. The method of claim 1, wherein:
the sequential implication comprises an antecedent sequence and a consequent property and, once the antecedent sequence has occurred, the sequential implication discards later occurrences of the antecedent sequence until the consequent property is resolved;
a counterpart suffix implication comprises the same antecedent sequence and consequent property, but also considers later occurrences of the antecedent sequence before the consequent property is resolved; and
converting the assertion to the deterministic finite automaton comprises:
generating a first finite automaton for an assertion for the counterpart suffix implication, the first finite automaton comprising a plurality of states and state transitions, including an initial state and a self-loop from the initial state to itself; and
modifying the first finite automaton to account for a difference between the sequential implication and the counterpart suffix implication.

3. The method of claim 2, wherein modifying the first finite automaton comprises:
adding a condition to the self-loop based on whether the antecedent sequence has occurred but the consequent property has not yet been resolved.

4. The method of claim 2, wherein modifying the first finite automaton comprises:
pruning state transitions so that every activation of the initial state results in only a single run of the first finite automaton.

5. The method of claim 2, wherein the deterministic finite automaton for the sequential implication and the first finite automaton for the counterpart suffix implication have a same number of states.

6. The method of claim 1, wherein the sequential implication comprises an antecedent sequence and a consequent property, and the consequent property is a co-safety property.

7. The method of claim 1, wherein the sequential implication comprises an antecedent sequence and a consequent property, and converting the assertion to the deterministic finite automaton comprises determinizing the negated consequent property.

8. The method of claim 1, wherein:
the sequential implication comprises an antecedent sequence and a consequent property and, once the antecedent sequence has occurred, the sequential implication discards later occurrences of the antecedent sequence until the consequent property is resolved; and
the deterministic finite automaton comprises a plurality of states and state transitions, including an initial state and a self-loop from the initial state to itself; and the self-loop is conditioned on whether the antecedent sequence has occurred but the consequent property has not yet been resolved.

9. The method of claim 1, wherein machine-readable form of the deterministic finite automaton is a register transfer language (RTL) implementation of the deterministic finite automaton.

10. A system comprising:
a memory storing instructions; and
a processing device, coupled with the memory and to execute the instructions, the instructions when executed cause the processing device to:
receive an assertion for a sequential implication for a circuit design, wherein the sequential implication defines a nonoverlapping transaction in which new transactions are not allowed while an existing transaction is still pending;
convert the assertion to a deterministic finite automaton on finite words; and
synthesize the deterministic finite automaton into RTL code.

11. The system of claim 10, wherein the deterministic finite automaton comprises a plurality of states and state transitions, and the states are implemented in the RTL code according to a logarithmic encoding.

12. The system of claim 10, wherein the deterministic finite automaton comprises a plurality of states and state transitions, and the states are implemented by counters in the RTL code.

13. The system of claim 10, wherein the deterministic finite automaton comprises a plurality of states and state transitions, and the RTL code encodes incoming state transitions to the states.

14. The system of claim 10, wherein the assertion for the sequential implication is expressed in SVA (System Verilog Assertions).

15. The system of claim 10, wherein the deterministic finite automaton comprises a plurality of states and state transitions, including an accepting state that corresponds to failure of the assertion.

16. The system of claim 10, further comprising at least one of:
a software simulation system that simulates operation of the RTL code;
a formal verification system that verifies operation of the circuit design by applying a formal verification to the RTL code; and
a hardware emulator that emulates operation of the RTL code.

17. A non-transitory computer readable medium comprising stored instructions, which when executed by a processing device, cause the processing device to:
receive an assertion for a transaction defined by a request and a grant, wherein an attempt begins upon occurrence of the request, the attempt is resolved upon success or failure of the grant, and additional attempts are discarded if a current attempt is not yet resolved;
converting, by a processing device, the assertion to a deterministic finite automaton on finite words, the deterministic finite automaton having a plurality of states and state transitions; and
verifying operation of the circuit design based on the deterministic finite automaton.

18. The non-transitory computer readable medium of claim 17, wherein the sequential implication can be either (a) the attempt begins at a same time that the request occurs, or (b) the attempt begins immediately after the request occurs.

19. The non-transitory computer readable medium of claim 17, wherein the deterministic finite automaton includes a single accepting state and a single rejecting state; and each attempt resolves to one of either the accepting state or the rejecting state.

20. The non-transitory computer readable medium of claim 17, wherein the current attempt must be resolved in a bounded finite time.
